(19) United States
(12) Patent Application Publication
(10) Pub. No.: US 2003/0225599 A1
(43) Pub. Date: Dec. 4, 2003

(54) SYSTEM AND METHOD FOR DATA AGGREGATION

(75) Inventors: Michael E. Mueller, Scottsdale, AZ (US); Derek D. Gentry, Scottsdale, AZ (US); Craig Pozen, Scottsdale, AZ (US); Skyler Cota, Scottsdale, AZ (US)

Correspondence Address: SNELL & WILMER, ONE ARIZONA CENTER, 400 EAST VAN BUREN, PHOENIX, AZ, 850040001

(73) Assignee: REALTY DATATRUST CORPORATION, Scottsdale, AZ (US)

(21) Appl. No.: 10/250,002

(22) Filed: May 27, 2003

Related U.S. Application Data
(60) Provisional application No. 60/384,994, filed on May 30, 2002.

(51) Int. Cl. G06F 17/60; H04K 1/00

(52) U.S. Cl. 705/5

(57) ABSTRACT

Systems and methods of reserving a rental property include the automated delivery of property management data, located at various property management computers, to a centralized database and the translation of the data into a universal format. A centralized property reservation system, associated with the centralized database, reserves a specific property, such as a specific apartment unit, in real time. The reservation may be established by, for example, annotating the record of the property in the centralized database. Furthermore, a user may be pre-screened online with respect to a specific property. The systems and methods are also configured to provide lead information to the property managers.

### CROSS REFERENCE TO RELATED APPLICATIONS

This application claims priority to, and the benefit of, U.S. Provisional Application No. 60/384,994, filed May 30, 2002, which is incorporated herein by reference.

### FIELD OF INVENTION

The present invention generally relates to reservation systems and methods, and more particularly, to systems and methods for aggregating unit level apartment availability information and permitting reservation of a particular unit.

### BACKGROUND OF THE INVENTION

Reserving an apartment is often a difficult task which may include multiple steps and involve a great deal of time. Even with the expansion of the internet, the apartment searching process is slow, cumbersome and only provides general information. For example, although some apartment complexes use internet websites for marketing their living accommodations, these websites often provide little more than the physical location and contact information for the apartment complex. Other websites may also show the layout of the complex in a map like form and/or provide details on various apartment models or styles. Thus, interested patrons may browse the website and form an opinion as to what model of apartment best suits their taste, budget, space requirements, and the like.

Unfortunately, many apartment hunters often then visit the complex to continue the rental application process. Often, the apartment hunters visit the complex only to find that a desired style of apartment is not available or that the only available unit is undesirable (e.g., overlooks a freeway). A suitable option for an apartment hunter to determine online whether a specific unit is available did not previously exist. Furthermore, the apartment hunter could not reserve a particular unit in real time.

A few existing apartment related websites may provide an online blank application form that can be printed and mailed to the apartment complex to start the application process. However, in the past, apartment hunters could not obtain an online pre-qualification, in real time, in order to rent a specific apartment. Thus, the apartment hunter may waste time researching an apartment for which the apartment hunter is not likely to qualify as a potential renter.

On another level, internet listing services (“ILS”) assist apartment hunters in searching for a type of apartment from among many available apartments in a community. However, even if each ILS somehow is aware of the current unit level apartment availability (for example, on a daily basis), there is a likelihood of double booking. For example, two different ILSs may each reserve the same unit on the same day. These, and other difficulties, create undesirable delays and frustrations for apartment hunters, and may reduce the ability for property managers to attract renters and increase occupancy rates. Many of these features and functionalities have been unavailable due to the difficulty of aggregating data from disparate, often antiquated, property management computer systems.

### SUMMARY OF INVENTION

Systems and methods of reserving a rental property include the automated delivery of property management data, located at various property management computers, to a centralized database and the translation of the data into a universal format. A centralized property reservation system, associated with the centralized database, reserves a specific property, such as a specific apartment unit, in real time. The reservation may be established by, for example, annotating the property record of the property in the centralized database. Furthermore, a user may be pre-screened for credit worthiness online with respect to a specific property. The systems and methods are also configured to provide lead information to the property managers.

### BRIEF DESCRIPTION OF DRAWINGS

A more complete understanding of the present invention may be derived by referring to the detailed description and claims when considered in connection with the Figures, wherein like reference numbers refer to similar elements throughout the Figures, and:

FIG. 1 illustrates a block diagram overview of an exemplary apartment reservation system in accordance with an exemplary embodiment of the present invention;

FIG. 2 illustrates an exemplary method for updating a centralized apartment reservation server database in accordance with an exemplary embodiment of the present invention;

FIG. 3 illustrates an exemplary method for checking the availability of an apartment unit in accordance with an exemplary embodiment of the present invention;

FIG. 4 illustrates an exemplary method for reserving an apartment unit, and generating leads in accordance with an exemplary embodiment of the present invention; and

FIG. 5 illustrates an exemplary method for pre-qualifying in accordance with an exemplary embodiment of the present invention.

### DETAILED DESCRIPTION

The detailed description of exemplary embodiments of the invention includes the accompanying figures, which show exemplary embodiments by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the following detailed description is presented for purposes of illustration only and not of limitation.

The present invention includes a system and method for automatically populating a centralized database with availability data from more than one system. In accordance an embodiment of the present invention, a system and method are provided for automatically populating a centralized database with unit level availability data from more than one property management system. In accordance with other aspects of the present invention, a system and method are provided for facilitating online reservations for a specific apartment unit in real time. For example, a user may electronically select a particular apartment unit and pre-qualify for that unit. In another example, a user may also remove that unit from the centralized database to “hold” the specific selected unit. In accordance with yet further aspects of the present invention, a user browsing an ILS website may simply perform a single action (e.g., select a link) to check the availability of apartment in the centralized database.

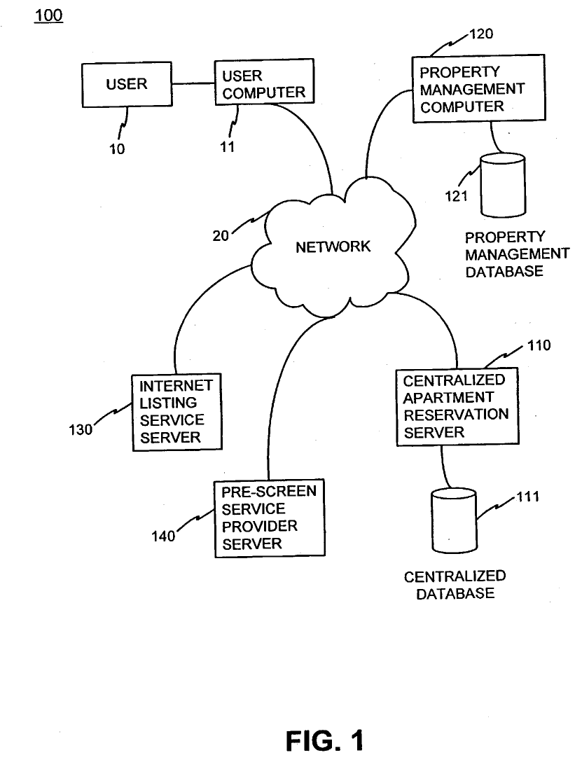

In general, with reference to FIG. 1, an exemplary apartment reservation system 100 is illustrated. Apartment reservation system 100 includes a centralized apartment reservation server 110 (“CARS”), a property management computer 120, and an Internet Listing Service (“ILS”) server 130, which are configured to communicate with each other via a network 20. ILS server 130 may be configured to communicate, via a network 20, with a user 10 using a user computer 11. ILS server 130 may facilitate identifying an apartment complex and/or style of apartment of interest to user 10. User 10 may then check the availability of specific units of a selected apartment type and at a selected apartment complex, by communicating with CARS 110. CARS 110 is any hardware, software and/or device configured to accumulate unit level data on properties (e.g., apartments) from one or more property management computers 120. If user 10 indicates a desire to reserve a unit, CARS 110 is configured to hold the particular apartment and/or communicate the reservation back to the property management for that apartment.

The present invention may be described in terms of apartment availability; however, one skilled in the computing arts will appreciate that the present invention may apply to determining the status or availability of any product, service and/or system now known or hereafter developed. For example, a similar system and method may be applicable to the availability status or reservation of a timeshare, a plot of land, campgrounds, self-storage units, dormitories, college housing, vacation rental property, housing for senior assisted living communities, and/or the like.

As those skilled in the art will appreciate, user computer 11 may include an operating system (e.g., Windows NT, 95/98/2000, Linux, Solaris, etc.) as well as various conventional support software and drivers typically associated with computers. User computer 11 can be in a home or business environment with access to network 20.

In an exemplary embodiment, access is through the Internet through a commercially-available web-browser software package.

More particularly, and as further described in the attached schematic exemplary diagram, in an exemplary embodiment, the system may include one or more servers or other computing systems that may further include a processor for processing digital data, a memory coupled to said processor for storing digital data (including text, photographs, site plans, availability, and/or the like), a plurality of databases, an input digitizer coupled to the processor for inputting digital data, an application program stored in said memory and accessible by said processor for directing processing of digital data by said processor, a display coupled to the processor, and memory for displaying information derived from digital data processed by said processor.

The user may interact with the system via any input device such as a keyboard, mouse, kiosk, personal digital assistant, handheld computer (e.g., Palm PilotÁ®), cellular phone and/or the like. Similarly, the invention may be used in conjunction with any type of personal computer, network computer, server, workstation, minicomputer, mainframe, or the like running any operating system such as any version of Windows, Windows NT, Windows 2000, Windows 98, Windows 95, MacOS, OS/2, BeOS, Linux, UNIX, Solaris or the like.

Communication between the computers may be accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. It will be appreciated, that many applications of the present invention could be formulated. One skilled in the art will appreciate that the network may include any system for exchanging data or transacting business, such as the Internet, an intranet, an extranet, WAN, LAN, satellite communications, and/or the like. It is noted that the network may be implemented as other types of networks, such as an interactive television (ITV) network.

The computing units may be connected to each other via a data communication network. The network may be a public network and assumed to be insecure and open to eavesdroppers. In the illustrated implementation, the network may be embodied as the internet. In this context, the computers may or may not be connected to the internet at all times. For instance, user computer 11 may employ a modem to occasionally connect to the internet, whereas ILS server 130 and CARS 110 might maintain a permanent connection to the internet.

Moreover, although the invention is frequently described herein as being implemented with TCP/IP communications protocols, it will be readily understood that the invention could also be implemented using IPX, Appletalk, IP-6, NetBIOS, .NET, OSI or any number of existing or future protocols. Moreover, the system contemplates the use, sale or distribution of any goods, services or information over any network having similar functionality described herein. Specific information related to the protocols, standards, and application software utilized in connection with the Internet may not be discussed herein. For further information regarding such details, see, for example, Dilip Naik, Internet Standards and Protocols (1998); Java 2 Complete, various authors, (Sybex 1999); Deborah Ray and Eric Ray, Mastering HTML 4.0 (1997). Loshin, TCP/IP Clearly Explained (1997). All of these texts are hereby incorporated by reference.

The systems may be suitably coupled to a network via data links. A variety of conventional communications media and protocols may be used for data links. Such as, for example, a connection to an Internet Service Provider (ISP) over a local loop as is typically used in connection with standard modem communication, cable modem, Dish networks, ISDN, Digital Subscriber Line (DSL), or various wireless communication methods. One or more of the computing systems described herein might also reside within a local area network (LAN) that interfaces to the network via a leased line (T1, D3, etc.). Such communication methods are well known in the art, and are covered in a variety of standard texts. See, e.g., Gilbert Held, Understanding Data Communications (1996), hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

Property management computer 120, in one exemplary embodiment of the present invention, is any hardware and/or software configured to run property management software. The property management software may be any software that, among other things, keeps track of the rent roll, unit status, occupancy, vacancies, and/or upcoming vacancies of the property. Some property management systems may store such data in a central server, ASP, or enterprise model. In another embodiment, the property management computer 120 may be further configured to communicate with a property management database 121 that is configured to store data related to the individual apartments. For example, property management database 121 may store the cost of rent for a particular unit, the occupation status of the particular unit, and similar data. It is often the case that property management software, the computer running the software, and its operating system are older technology or versions, vary from computer to computer and/or store data in different formats at the various property management sites. Nevertheless, a finite number of programs and operating systems exist and thus, property management computer 120 may further be configured to run a VaultWare program.

The VaultWare program may be customized to the property management computer and/or local software. The VaultWare program is configured to provide selected property management data to CARS 110. For example, VaultWare may be configured to access property management database 121 to obtain the latest data for forwarding to server 110 via network 20. The data may be provided to CARS 110 on a periodic basis (such as at the end of each day), in real time, batch mode, each time a change is made to the database, on demand, and/or otherwise.

Centralized Apartment Reservation Server 110 (“CARS”) may be any suitable hardware and/or software configured to (1) receive data from one or more property management computers 120, (2) store data in a centralized database 111, (3) present data regarding the availability of selected apartment units, and (4) reserve a selected apartment unit. CARS 110 may furthermore be configured to facilitate pre-screening of individuals applying to rent a particular apartment. Also, CARS 110 may be configured to provide referrals to apartment complexes and to facilitate crediting the referring ILS 130.

ILS server 130 is any software and/or hardware suitably configured to present text and/or graphical information to user 10, via network 20, for assisting user 10 in the general process of finding an apartment to rent. For example, the ILS server 130 may be configured to run a search engine and/or to present a web page to user 10 presenting various apartment complexes and amenities associated with each complex. The user may browse such a website and identify the apartment complex, the model of apartment and/or the amenities that the user prefers. In one exemplary embodiment, the ILS website presents a link, or “Check Availability” function or button, that with a single action by the user (e.g.; mouse click, light pen selection, touch screen selection, biometric scan, keystroke) re-directs user 10 to a web page associated with CARS 110. In addition to redirecting user 10 to CARS 110, ILS server 130 may transmit to CARS 110 additional data such as an identifier of the apartment complex and model of interest, an identifier of the referring ILS, user profile information, and/or the like. In accordance with another exemplary embodiment of the present invention, ILS server 130 may be configured to obtain information from CARS and perform similar functions at the ILS website.

The term “webpage” as it is used herein is not meant to limit the type of device, formats and applications that might be used to interact with the user. For example, a typical website might include, in addition to standard HTML documents, various forms, Java applets, .jpg images, Javascript, active server pages (ASP), common gateway interface scripts (CGI), extensible markup language (XML), dynamic HTML, cascading style sheets (CSS), helper applications, plug-ins, and/or the like. Furthermore, similar functionality may be implemented in wireless devices, kiosks, and/or the like.

The property management computer 120 may be any hardware and/or software suitably configured to store apartment unit level data in property management database 121. Although the categories/type of data in property management database 121 is generally the same, the format for storing such property management data may differ widely from property management computer to property management computer, from one software package to the next, and even within particular software packages. Therefore, the property management data may be translated to a common format and stored in a centralized database, e.g., CARS 110. CARS 110 may be configured to store the translated property management in centralized database 111 with a common or standard format. The property management data stored in CARS 110 may be updated from time to time to create a substantially real-time data store of any changes as the changes occur. The data from the property management databases may be formatted into encrypted XML files based on an Open Data Standard (ODS) for the apartment industry. This ODS is more fully described at the Multi Family Data Exchange web site (www.mfdx.com), the contents of which are hereby incorporated by reference. It is also contemplated in one embodiment that data formats include the MITS-Multi Family Information Technology standard.

The property management data, regardless of format, may include various types of data. For example, property management data may include the current pricing of specific units and/or amenities. Property management data may further include features or amenities associated with specific units, and possible additional amenities that are available with that particular apartment unit. In addition, property management data may include image data. Image data may include thumbnail images, exterior/interior views, floor plan images, graphical representations of the property, pictures off the balcony of a specific unit, and or the like. In general, the property management data is unit specific, however, some information may be common to the entire complex, such as the pool and other common grounds, pet types allowed, lease periods, and/or the like (master data). In the CARS database 111, each unit may be associated with-one or more identification codes or unique IDs, for facilitating query and identification of particular units.

One skilled in the art will also appreciate that, for security reasons, databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

Databases discussed herein may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first. data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

More particularly, in one embodiment, the application is written in Visual Basic 6. In another embodiment, the application is in Visual Basic .NET. Each implementation may be assigned a unique installation identification number that can be used, if needed, for focusing information to or addressing any issues relevant to that specific installation. The system may, for example, use the Microsoft Data Engine (MSDE) to store its data locally within the application.

The computer may provide a suitable website or other Internet-based graphical user interface that is accessible by users.In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Intervase, etc., may be used to provide an ADO-compliant database management system.

Apartment reservation system 100 may further include a pre-screen service provider server 140 which is any hardware and/or software suitably configured to perform pre-screening of applicants for specific units selected at CARS 110. CARS 110 may provide information to pre-screening service provider server 140 regarding the apartment reservation applicant and the particular apartment desired by the applicant. For example, the pre-screen information may include the applicant(s) name, social security number, date of birth, previous addresses, and/or the like. Alternatively, some of this information may be entered by the applicant directly at the prescreen service provider 140 web page. In addition, the referral information may identify the monthly rent and/or other financial requirements associated with a selected apartment as drawn from centralized database 111. The prescreening service provider is configured to make a determination as to the worthiness of the applicant, and to return to the user and/or CARS an approval, disapproval, approval with additional conditions, and/or the like for the pre-screened application and as determined by the scoring model. The scoring model may, for example, be property specific.

The system generally includes a method for facilitating the aggregation of data from databases to distribute over a network or display specific information in, for example, real-time. In one embodiment, the method facilitates the transfer of data (e.g., real estate, apartments, senior housing, storage, etc.) from local software systems (e.g., Property Management Systems) into a centralized, universal information repository or device (e.g., a Global Distribution System (GDS), server, database, file, series of files, disk cluster, FTP site), in order to consolidate the information. The centralized repository storage process may also convert the information into a standardized format (e.g., XML, text file, etc). Furthermore, the method includes distributing the standardized data over a network (e.g., Internet, Intranet, etc.) or displaying information to consumers (e.g., availability, unit-level features, management company information, property information, site information, model information, etc) on a publicly or privately accessed device, software or system (e.g., website, database, file, application, etc). While the methods may be disclosed herein with respect to real estate information as an exemplary embodiment, one skilled in the art will appreciate that the functionality discussed herein may apply to any type of data or information.

The information from the repository can be accessed a number of ways. User computer 11 can receive content through direct file transfers, linking to the information directly from a web site or page or requesting the information from the repository servers. An example of this technology is the ability to display unit-level availability of specific rental units by sending a request to the repository servers giving specific information about the type of unit desired. The user may perform an action or series of actions (e.g., selecting, pressing button, speaking, touching, etc) to display the desired information. For example, the user may select a “check availability” icon to obtain real time availability data including, for example, apartments that are available for rental immediately. In another embodiment, the system includes facilitating the aggregation of apartment data or sales leads and facilitating distribution of such sales leads or data to advertising and marketing vendors.

In yet another exemplary embodiment, the system facilitates auditing of the rent roll to determine whether a particular user who reserved a particular unit actually completed the transaction and signed a rental contract for the apartment. As such, the system may be configured to serve as an auditing tool and to evaluate the effectiveness of the referring ILS. The software may be configured as a modular application, allowing it to adapt to most Property Management systems easily. The virtual seamless flow of data is facilitated by each of the exemplary modules outlined below working in conjunction with one another.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and/or the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

In accordance with an exemplary embodiment of the present invention, methods are provided for facilitating the reservation of an apartment. An apartment reservation method comprises one or more of the following steps: (1) Updating the software associated with the reservation method, (2) updating the data at a centralized apartment reservation server with data from at least one property management system, (3) facilitating a users efforts to check availability of an apartment, and (4) reserving an apartment.

In accordance with an exemplary embodiment of the present invention, the software utilized in connection with the property management computer system may be updated in an automated manner. For convenience, the software that resides on the property management computer is identified as VaultWare client software. It is recognized that from time to time, it may be desirable to enhance the VaultWare client software through updates that incorporate added functionality, improvements, and other changes. However, because the property management systems are remotely located, and to improve the speed of implementation of software changes, at least one of the VaultWare client software programs may be an updater application that allows the VaultWare client software to be substantially “self-healing” and automatically updated.

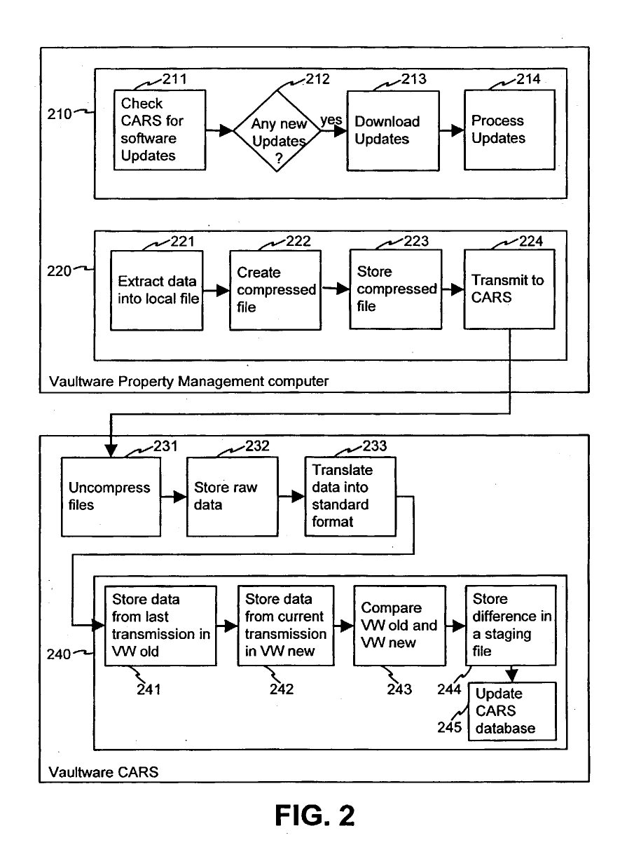

With reference to FIG. 2, a method 210 of updating the VaultWare client software may be initiated by the updater software, which is configured to interrogate CARS 110 (step 211) to see if any new updates exist on the system. If new updates exist, the updates may be downloaded (step 213) and processed (step 214). In one exemplary embodiment, the system may be configured to check secure servers to compare the most current versions of the scripts, translators, files and even the software executable itself. If the updater application finds any files that need updating, it may download the files, store the files locally and/or suitably process the files. It is noted that each property management system is associated with a unique ID. Furthermore, one or more of the scripts, translators, files, and executables may be customized to the particular property management system. Utilizing these unique ID's, the updated files can be directed at specific sites as appropriate. Also, global updates may be directed to all sites where appropriate. It is noted that CARS database 111 may additionally contain one or more identifiers of the programs, files, applications, etc. that are used by a particular property management computer.

The updater application may be configured to perform its function from time to time as needed. For example, the updater application may be configured to check for updates (step 211) on a periodic basis, such as once a day. The application may be configured to check for updates at the beginning or end of each communications session with CARS 110. Furthermore, the updater application may be prompted by CARS 110 to initiate updating sessions. The system may be self-sufficient and, if desired, can shut itself down, restart and continue processing information once all updates are received and installed.

In general, the apartment reservation system includes a method for aggregating/updating the data at CARS 110 with data from at least one property management system. This process may be accomplished in more than one way. For example, in one exemplary embodiment of the present invention, property management data is transmitted to CARS 110 where it is processed and used to update CARS database 111. In another exemplary embodiment, the property management data is first processed at the property management computer 120 and changes in the data are then transmitted to CARS database 111. For purposes of further illustration, these two exemplary methods are discussed in greater detail. However, other similar methods may also be used to communicate changes in disparate property management systems to a central database. For example, CARS 110 may be configured to receive a pre-formatted data file from computer 120, wherein the property management software itself is configured to export and transmit the data to CARS 110.

With reference to FIG. 2, the VaultWare client software is configured to retrieve all data, or a subset of all data in the property management database (step 221). The data may be retrieved by use of a direct link interface, e.g., Open DataBase Conductivity “ODBC”, and ADO “visual basic”. This data may be converted into a compressed file (step 222), such as a ZIP file. The data may then be stored on the property management system (step 223). Next, the data (generally in compressed form) is transmitted to CARS (step 224). The transmission is made, for example, via FTP or HTTP. Transmission to CARS may be initiated by the VaultWare client software itself. The transmission may be scheduled to occur at regular intervals, at the end of each business day, when the property management software is turned off, and/or the like. Furthermore, VaultWare client software may be prompted by external inquiry to retrieve the data and/or transmit the data. For example, CARS 110 may send a request to VaultWare client software at the property management computer 120 and that request may initiate the transmission of data.

At CARS 110, the data is received and, if appropriate, uncompressed (unpacked)(Step 231). The data may be temporarily stored in memory or in the database (Step 232). The data is next translated into a standard CARS database format (Step 233). Once converted into standard format, any changes in data can be updated in CARS database 111 (Step 240). Although various updating methods may be used, in one exemplary embodiment of the present invention, the translated data from the last transmission is stored in a VWOLD file (step 241) and the translated data from the new transmission is stored in a VWNEW file (step 242). The VWOLD file is compared to the VWNEW file (step 243), and the differential data is placed in a staging file (step 244). The differential file is used to update the CARS database (Step 245). In another example, the new transmission is compared directly against the data residing in CARS database 111, and changes to data in that database are made as appropriate.

In accordance with another exemplary embodiment of the present invention, changes in data on the property management system are updated in CARS database 111 by first accessing property management database 121 and creating a copy of all the data in the property management database, or a subset thereof.The copy is, for example, a MSDE version of the structure within the property management database. The copied data may be translated into a standard data format. As described above, various comparison methods may be used to identify recent changes in the database. For example, the translated data used in the last transmission is stored in a VWOLD file. This can be done by emptying VWOLD and moving data in VWNEW to VWOLD. The newly translated data transmission is stored in the VWNEW file. The VWOLD file is compared to the VWNEW file, and the differential data is placed in a differential file. The differential file contains the differences between the two files with each differential record marked as insert, update, or delete. The differential file is then transmitted to CARS 110. As described above, this process and transmission may be self-initiated (push) or externally initiated (pull). In this scenario, CARS is configured to receive the differential data and update the CARS database accordingly.

In yet another exemplary embodiment, changes to the property management database are captured as the changes are made, and these changes are translated and/or transmitted to CARS. In one example of translation, “2B2BA” is translated into “2 bedroom, 2 bath”, or some other standardized format that is understandable. Thus, in any of these embodiments, CARS database 111 may represent the current data of many disparate property management systems, with an accuracy as high as the frequency of updates relative to the rate of change of the property management database. Of course, it is recognized that the property management database is only as accurate as the information timely added to the property management database.

Regardless of what method is used to communicate the property management data to CARS database 111, translation (discussed above) may be required in many cases. The translators of the present system may be built as modular pieces of code that can be pulled out and replaced easily, for example, COM objects. The translators are configured to convert the data from each property management site into a substantially universal data format. As new property management software is developed, translators may be written or enhanced as desired and the software can capture new translators through the update process described above. Translation may be performed, for example, using suitable data mapping applications.

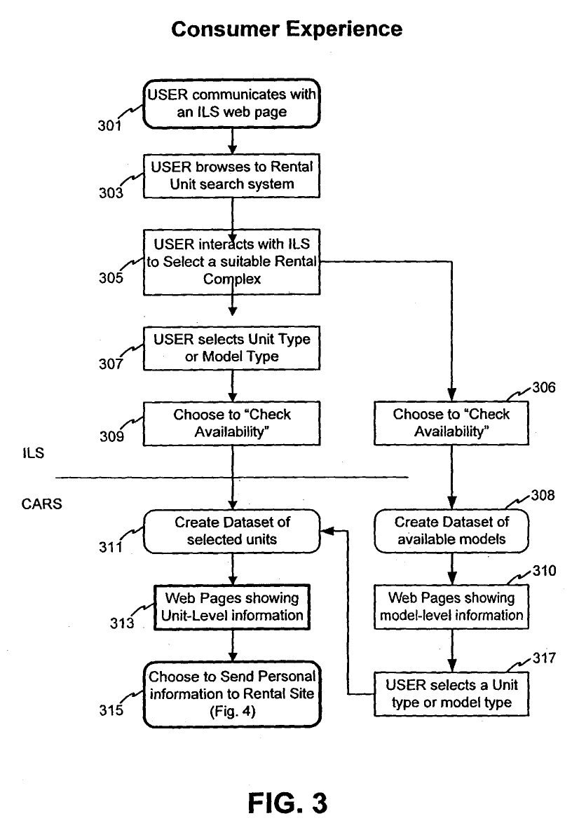

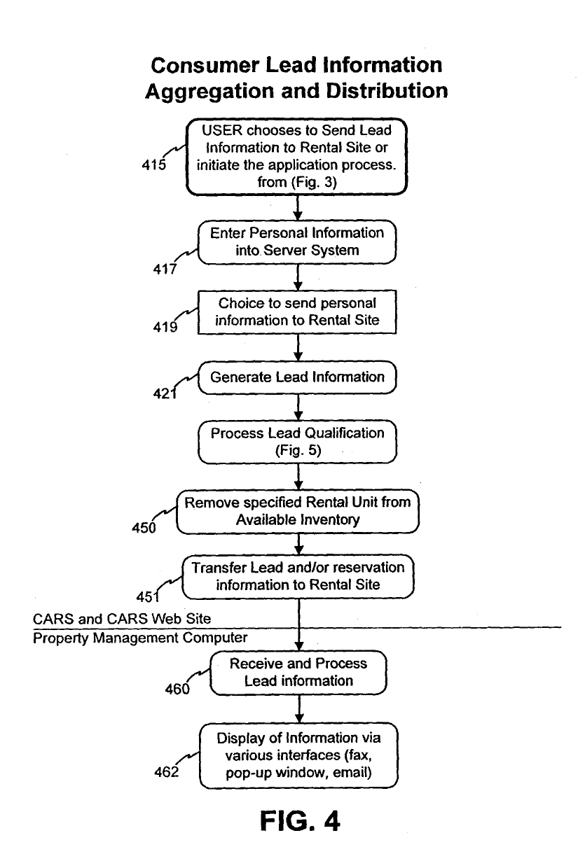

The apartment reservation method may further include the process of the user accessing the aggregated data in CARS 110, often via an internet listing service (“ILS”). In accordance with an exemplary embodiment of the present invention, and with reference now to FIG. 3, user 10 communicates with an ILS server 130 (Step 301). User 10 provides inputs to indicate the user's related apartment preferences. For example, the user may navigate a website that provides search, filtering, and/or selecting tools for presenting the user with one or more apartment complexes that are in the desired geographical location, the user's price range, and that offer amenities suitable to user 10 (Steps 303 and 305). User 10 may select a suitable apartment complex(es) (Step 305). User 10 may further provide inputs to indicate the model or apartment floor plan that is preferred by the user, and to select options such as furnishings, storage, parking, and the like (Step 307). Having made such selections, the user may now wish to check the availability of such an apartment. The aggregation of the data in CARS database 111 facilitates the display of unit level information from the central data store, essentially independent of the source of the request. When a consumer is presented with rental site information, the ability to “check availability” of specific rental unit types, or models, can be enabled. Using a single action (e.g., select, selection, touch, light pen, voice, biometric input and/or the like) or plurality of actions, the consumer is able to obtain real-time or substantially real-time availability information of specific rental unit types or models.

In an exemplary embodiment, user 10 may select on a “Check Availability” button (Step 309). The check availability button is any link that causes user 10 to interact with CARS 110. The button may be any design, shape, color, and may have any or no label. In fact, the button may be no more than a “Next” button for proceeding to the next step in the application process. Furthermore, although described as a button, the check availability button may also be implemented as logical functions that connect user 10 with CARS 110. With momentary reference to FIG. 6, an exemplary apartment ILS web page shows generic information about a particular apartment model within an apartment complex, and includes a “Check Availability” button 610 for accessing unit level information, including unit availability information, in CARS 110.

That being said, in another exemplary embodiment, user 10 may interface with CARS before selecting a specific unit or model type. For example, user 10 may interact with an ILS to select a particular apartment complex (step 305), whereupon user 10 may select a “check availability” link or be automatically redirected to CARS 110 (step 306). With momentary reference to FIG. 7, an exemplary apartment ILS web page shows generic information about a various apartment models within an apartment complex, and includes a “Check Availability” button 710 for accessing model level information, including model availability information, in CARS 110. In this example, CARS 110 is configured to present to user 10 a data set showing models that are available within that apartment complex (step 308). Such information may be displayed to user 10 via a web interface (step 310). In this example, user 10 may select a unit/model type(s) from the available models (step 317) and proceed to view unit level availability information (step 311-313).

The process of displaying unit level availability may include, in one embodiment, suitably linking user 10 to the information (e.g. a hyperlink, direct page call, record pointer) by calling a web page residing on a server system (CARS) with access to the CARS database 111. A set of parameters (e.g., IDs) that specify information, such as the model of unit desired, and/or the ILS source, may be transmitted from the ILS server, for example, to CARS in order to filter the search results. The servers suitably match the IDs passed to it with the central data store to identify the units that match the request (step 311). By returning a record set of the matching units, the servers then display to the user the desired units and specific information associated with the units (step 313). Such information may be for example, in the case of apartment communities, date of availability, unit-level features, digital images, floor or level. This information may all be available in CARS database 111. Furthermore, this information may be displayed in various formats as a list of available units or as individual units. As such, this functionality facilitates a more granular level of information due to the direct feeds from the source of data and the frequency of its updates. Once presented with such granular information, the consumer may be able to make much more educated decisions about the rental of multiple types of units.

The system may be further configured to co-brand the displayed information with the logos, colors, and/or styles of the selected apartment, its property management company, and/or the referring ILS. Thus, the system may facilitate the seamless presentation to the user of information regarding apartment availability.

Although exemplary embodiments of present invention may be described with reference to an ILS, any hardware and/or software that facilitates identifying and/or selecting an apartment complex and/or selecting apartment models may be used as a platform for directing user 10 to the CARS system. In an exemplary embodiment, the user is redirected from the ILS website to a website associated with CARS 110. In some embodiments, the redirection is a substantially seamless process where the user is not aware of leaving the previous website, and the user may be returned to the referring website upon completion of the supported activities at the CARS web-site. The redirecting process may be configured to send information to CARS relating to the apartment, model, and amenities of interest to the user. This information accompanying the redirected user can be used by CARS without requiring user 10 to re-enter the information.

Furthermore, it is contemplated that the same functionality supported at the CARS site may alternatively be implemented at referring websites that are appropriately configured. For example, subscribing ILS providers may download applications from CARS that would run the queries and other applications on the ILS website. These applications could search for data in the CARS database, without ever redirecting user 10. Thus, although the information displaying web interface is frequently described herein as being associated with CARS 110, in other embodiments, third party websites, including the ILS websites may be configured to communicate with CARS 110 to present model and/or unit availability on the third party web site.

In either event, the user is presented with information related to the particular type, model, or floor-plan of the apartment of interest (Step 313). The user may further select a particular unit, amenities, and/or the like. During this process, CARS 110 may access various CARS databases 111. For example, CARS 110 may access a rental unit database containing unit specific and general apartment information. CARS 110 may also access a client database containing the personal information of users who have visited the site before. CARS 110 may also access a transaction database storing information on the current transaction.

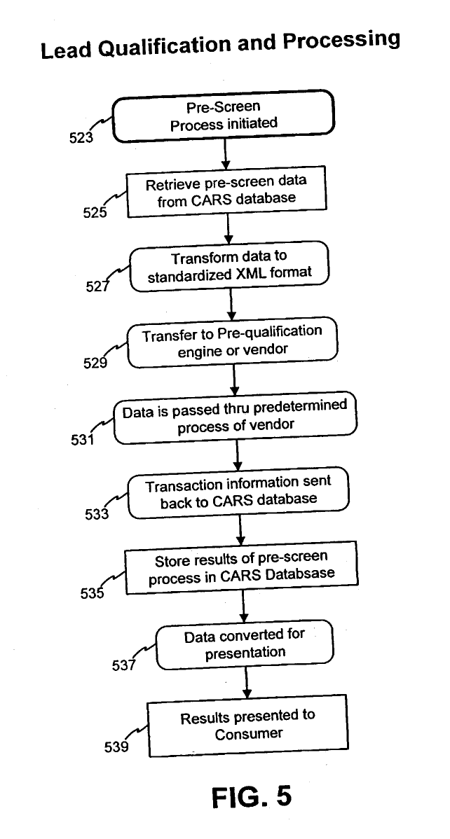

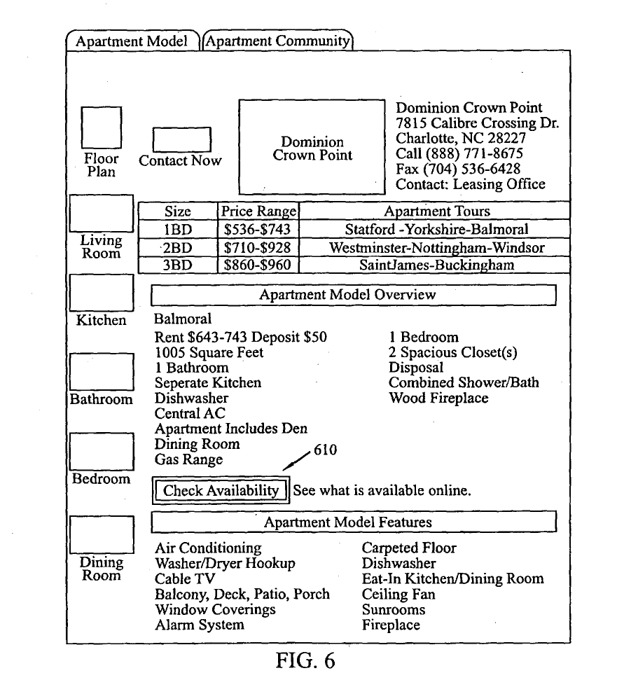

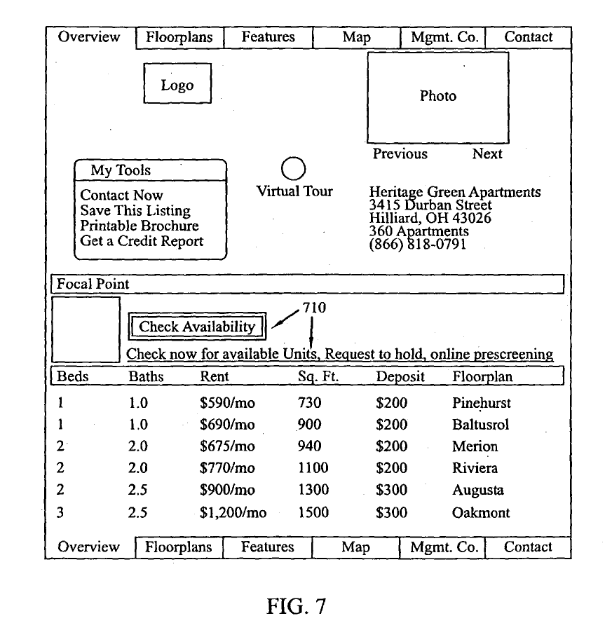

User 10 may wish to start the application process for a specific apartment unit. The user may be presented with the option to initiate the application process or provide information to the apartment complex (Steps 315 and 415). This process is further described with reference to FIGS. 4 and 5. At this stage, it may or may not be desired to obtain additional information from user 10 via, for example, a web interface (Step 417). This step may involve further interaction with various databases, e.g., the client database, in CARS database 111.

By storing the client information, upon request, the consumers' information may be passed to multiple third parties (e.g., prescreening vendors, apartment communities, rental office, etc.). In some instances, the consumer information may further be translated into a format suitable for communication of the data with the third party. Such formats and/or translations may depend on the specific applications used by the third party. In some embodiments, the consumer may first grant consent to send their data to a specific apartment or other third party. CARS 110 may be configured to send a lead or prospective renter information to the apartment or agents of the apartment. This transfer of information may occur a number of ways, such as, for example XML file transfer, direct data feed to client data stores, dynamic display, etc. User 10 may chose to have CARS send a referral to the property managers for apartment(s) of interest (Step 419). In this event, CARS may prepare a referral containing appropriate information regarding the user, the apartment of interest, the ILS referring website, and/or the like (Step 421).

Delivery of this referral or lead information may occur in various different ways (Step 451). For example, the referral may be stored in CARS database 111 where it may be retrieved upon request by the property manager. In this embodiment, for example, a property manager having provided a correct authorization code to CARS 110 is permitted to view, print, and/or download any new leads stored in CARS database 111.

CARS may also be configured to send an email, pop-up window, a letter, a fax, and/or the like for alerting the appropriate property manager of the existence of a new lead at the CARS website. In another exemplary embodiment, CARS is configured to send a signal to the VaultWare client software, and the VaultWare client software is configured to display an alert or message regarding the existence of the new lead. In various embodiments, the lead may be transferred to the property manager with the alert. For example, the lead information can be contained in an email message. The property manager can choose to accept and import the queued lead(s) into property management computer 120, such as in an XML file (Step 460). Such techniques may result in little or no rekeying of lead information by the property management employees. The leads may then be viewed at the property management site (Step 462). With each referral, appropriate accounting and tracking of referrals may be made, such as with respect to the referring ILS website.

The software at the property management computer may facilitate retrieving the information from the servers by communicating a set of parameters (e.g., IDs) to CARS 110. In one embodiment, the IDs are the unique identifier for the application installation and/or the specific identifier of the lead itself. The location ID number may be a 12-digit string of characters, created using an algorithm using the current date, time and/or a random multiplier. Once CARS 110 receives the request and the identifiers associated with it, the lead information specific to that apartment complex can be transferred by any of the means described herein, and displayed on the client devices.

In many instances, an apartment hunter may desire to initiate the application process immediately. In accordance with an exemplary embodiment of the present invention, CARS is configured to, upon request by user 10, pre-qualify or pre-screen user 10 for credit worthiness for a specific apartment complex. The pre-screening process may also include pre-screening through use of references, criminal history and/or other information useful in determining whether to approve an application and as permitted by law. Pre-screening for credit worthiness is significant because it is not practical to generically pre-qualify for renting an apartment. In other words, pre-screening is generally tied to a specific apartment, a specific rent/down-payment, and/or other factors that the apartment complex may specify. Other factors may include, for example, age restrictions for adult living communities, income limitations, and/or the like.

Therefore, in view of the unit level information that may be provided in exemplary embodiments of the present invention, it is further possible to pre-screen an applicant for a specific apartment. By overcoming this hurdle, it may further be possible to complete the entire apartment application process, or a significant portion thereof, online. For example, CARS 110 may be configured to integrate with a rental forms provider which generates legal documents for property management use in renting properties. This integration facilitates the completion of rental applications on-line. In various exemplary embodiments, the initial deposit may be collected on-line and/or portions of the application may be automatically completed with the unit level and consumer information.

The pre-screening process may be initiated by a user selecting a button, or otherwise indicating a desire to be pre-screened for one or more selected apartment units (Step 523). Next, relevant data may be retrieved from CARS database 111 (Step 525). The relevant data may include information related to the applicant and/or information related to property specific parameters for rental qualification. The relevant pre-screen data is then converted into a standard format (Step 527). For example, the pre-screen data may be converted into an XML format by a COM object. Other formats may be used to the extent that such formats are compatible with pre-screening service provider formats. Next, the data may be transferred to a Pre-screen service provider (Step 529). The transfer may take place via any applicable data transfer mechanism, such as FTP, HTTP Post, and/or the like. The data, once received by the pre-screen vendor, is passed through the internal vendor process and a screening result is generated (Step 531). For example, the pre-screening result may be an “approved”, “denied”, “approved with restrictions” flag, or the like. The pre-screening result is transferred back to CARS, and once received by CARS, may be stored in CARS database 111 (Steps 533 and 535). The pre-screening result may be further converted for presentation to user 10 (Step 537 and 539). For example, the pre-screening result may be converted into HTML, or the like and presented via the CARS associated website to user 10.

The user may further be presented with the option of reserving the apartment (Step 450). In the context of the present application, the term “reserve” is to be construed to have a broad meaning. For example, reserving the apartment may mean that the apartment is removed from the CARS database, annotated as reserved, or restricted from view on an ILS or CARS. In this context, the apartment cannot be reserved by any other subsequent request that is sent, for example, from any ILS to CARS for that particular unit. However, it may still be the case that the “reserved apartment” is rented to a subsequent requester who goes to the apartment complex in person. This is so because the apartment complex database may not always be updated in real time.

In other embodiments, however, in conjunction with the reservation of an apartment in CARS, information is also sent to the apartment complex. This may take place in various different ways. For example, an alert may be sent to the apartment complex. The alert may be in the form of an email, a letter, a fax, or a digital alert. The digital alert may, for example be sent to the VaultWare software, which may be configured to present an alert dialog box on the screen of the apartment management computer. The software may be further configured to temporarily or otherwise reserve the apartment unit in the property management database itself.

Since the information is stored in one central location, the availability of selected apartment units can be updated dynamically in real-time (or almost immediately). The potential renter may now, upon a single action or plurality of actions, “Request to Hold” a specific unit and, thru a series of background check and credit approval functions, be approved, denied, or approved with further conditions to rent before physically visiting the site. If approved, a hold may be placed on that particular unit and that unit may be immediately removed from any other match lists that are retrieved from the CARS database III. As such, the risk of two people requesting to hold the same unit from two separate locations is reduced and/or eliminated.

Overall, the system may be configured to expand and/or adapt to multiple environments ranging from an individual property environment to an enterprise portfolio level. The system includes an easy and comprehensive method that allows an apartment owner or management company to utilize a uniform data exchange with multiple sources in order to achieve the presentation of unit availability.

The present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Any suitable computer-readable storage medium may be utilized, including hard disks, CD-ROM, optical storage devices, magnetic storage devices, and/or the like.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions, which execute on the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture, including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions, which execute on the computer or other programmable apparatus, provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

Benefits, other advantages, and solutions to problems have been described above with regard to specific embodiments. However, the benefits, advantages, solutions to problems, and any element (s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. a method for facilitating an online reservation, for a user, of a property unit from among at least two property units, the method comprising the steps of:
retrieving unit level property management data from a property management database associated with a property management computer, wherein said property management computer is associated with a property management system;
transmitting said property management data to a centralized property reservation server;
updating a centralized property reservation database, associated with said centralized property reservation server, with said property management data, wherein said property management data comprises unit level data on specific property units, wherein said property management data includes data from more than one property management systems; and
presenting to the user said unit level property data, including availability of a specific unit.

2. The method of claim 1 further comprising the steps of:
presenting to the user a check availability link at a first website; and
redirecting the user to a second website associated with said centralized property reservation server upon selection of said check availability link.

3. The method of claim 2 further comprising the step of reserving a specific unit within said centralized property reservation database upon request by the user.

4. The method of claim 2 wherein said property management data is translated to a universal standard format before said transmitting step.

5. The method of claim 2 wherein said property management data is translated to a universal standard format after said transmitting step.

6. The method of claim 2 wherein the property is an apartment complex, said centralized property reservation server is a centralized apartment reservation server (CARS), and said centralized property reservation database is a CARS database.

7. The method of claim 2 wherein the property is at least one of an apartment complex, a self storage facility, a senior assisted living complex, a dormitory, a timeshare, a plot of land, and a campground.

8. The method of claim 2 wherein said first website an internet listing service website.

9. The method of claim 2 further comprising the step of pre-qualifying the user, online, for a specific property unit.

10. A centralized apartment reservation system configured to facilitate the reservation of an apartment for a user, the system comprising:
a centralized database; and
a centralized apartment reservation server (CARS), configured to:
receive unit level property management data;
update said centralized database based on changes in said property management data, wherein at least a portion of said property management data is stored in said centralized database in a universal data format;
receive a request to check the availability of at least one apartment;
present unit level apartment data related to said at least one apartment, including unit availability information; and
reserve a specific unit.

11. The centralized apartment reservation system of claim 10 wherein said CARS is further configured to translate said property management data into said universal data format.

12. The centralized apartment reservation system of claim 10 wherein said CARS is further configured to facilitate pre-screening of the user for a specific apartment unit.

13. The centralized apartment reservation system of claim 10 wherein said request to check the availability of said at least one apartment originates from an internet listing service website.

14. The centralized apartment reservation system of claim 10 wherein said CARS is further configured to generate and transmit a referral to a property management system, wherein said referral comprises information about said user, the source of the referral, and the specific apartment unit of interest to said user.

15. A method for facilitating the reservation of a rental property, wherein said rental property is managed by a property management system, the method comprising the steps of:
receiving property management data from the property management system at a centralized property reservation server;
translating said data from a property management data format to a uniform property data format;
updating a centralized property reservation database with said data in said uniform property data format;
receiving a request to check availability of property as recorded within said centralized property reservation database;
retrieving unit level property data from said centralized property reservation database;
presenting said unit level property data for available property units; and
reserving a specific unit within said centralized property reservation database.

16. The method of claim 15 wherein said request to check availability of property is received from an internet listing service website.

17. The method of claim 15 further comprising the step of facilitating a pre-screening of the user for a specific property unit.

18. The method of claim 15 wherein the property is an apartment complex, said centralized property reservation server is a centralized apartment reservation server (CARS), and said centralized property reservation database is a CARS database.

19. The method of claim 15 wherein the property is at least one of an apartment complex, a self storage facility, a senior assisted living complex, a dormitory, a timeshare, a plot of land, and a campground.

20. The method of claim 15 further comprising the step of transmitting a lead to a property management system, wherein said lead comprises information about a user, said user's prescreening results and the specific property desired by said user.

21. A user selectable link displayed on a first website, said link comprising:
a “check availability” button, wherein said check availability button is configured to redirect the user to a second website that is associated with a centralized apartment reservation server (CARS), and wherein said CARS is configured to present to the user unit level apartment data and to permit the user to reserve a specific unit, wherein said CARS is configured to receive unit level apartment data from more than one property management system.

22. The user selectable link of claim 21 wherein said CARS is further configured to pre-screen the user as an applicant for a specific apartment unit.

23. A method for facilitating online interrogation, for a user, of the availability of a specific apartment comprising the steps of:
receiving a user selection of at least one apartment model on a first web site;
receiving the user selection of a “check availability” button associated with said first web site;
redirecting the user to a second web site, wherein said second web site is associated with a centralized apartment reservation server (CARS) and a CARS database, wherein said CARS database is populated and updated to reflect at least a portion of the data that is stored in at least two property management databases;
presenting unit level apartment data to the user; and
reserving a specific unit upon request by the user.

24. The method of claim 23, wherein said CARS is further configured to pre-screen the user for a specific apartment unit.

25. The method of claim 23, wherein said first web site is an internet listing service (ILS) web site.

26. A method of aggregating, within a centralized database, property data from a plurality of property management computers each associated with at least one property management database, wherein the centralized database is associated with a centralized server, the method comprising the steps of:
installing a software program on the property management computer, wherein said software program is configured to perform the steps of:
obtaining unit level data from a property management database associated with said property management computer; and
transmitting said unit level data to the centralized server for storage within the centralized database.

27. The method of claim 26, further comprising the step of translating said unit level data into an universal format, comparing the unit level data with unit level data from a previous transmission, and only transmitting the difference.

28. The method of claim 26, further comprising the step of compressing said data for transmission.

29. A method for facilitating an on-line reservation of an apartment comprising the steps of:
aggregating unit level information, from more than one apartment and more than one property management system, within a centralized apartment reservation database;
presenting said unit level information, wherein said unit level information comprises at least the availability of a selected apartment unit; and
reserving said selected apartment unit in said centralized apartment reservation database, wherein said centralized apartment reservation database substantially reflects the availability status of individual apartment units in more than one property management databases.

30. The method of claim 29 further comprising the step of forwarding lead information from a centralized apartment reservation system to a property management system.

31. The method of claim 29 further comprising the step of providing a link from an internet listing service web site to a website associated with a centralized apartment reservation server, wherein said internet listing service facilitates searching for an apartment complex, and wherein said internet listing service is configured to re-direct a user to said centralized apartment reservation system associated website.

32. The method of claim 29 further comprising the step of pre-qualifying an applicant for a specific apartment unit.

33. The method of claim 32 further comprising the steps of collecting information for an online application and submitting said online application.

34. The method of claim 29 further comprising the steps of:
receiving apartment data from a VaultWare program associated with a property management computer, wherein said VaultWare program is configured to automatically copy data from a property management database, to compress said data from said property management database, and to transmit said compressed data to said centralized apartment reservation system;
uncompressing said compressed data;
translating said uncompressed data to a universal format; and
updating said centralized apartment reservation database with changes identified in the transmitted data.

35. The method of claim 1 further comprising the steps of:
receiving apartment data from a VaultWare program associated with a property management computer, wherein said VaultWare program is configured to automatically copy data from a property management database, translate said data to a universal format, and to transmit said translated data to said centralized apartment reservation system; and
updating said centralized apartment reservation database with changes identified in the transmitted data compared against the last transmission.

36. An apartment reservation system for facilitating a user, who is on a user computer and browsing an internet listing service (ILS) website, to reserve a unit in an apartment complex having a property management computer for storing apartment data, the system comprising:
a centralized apartment reservation database;
a centralized apartment reservation server configured to receive the apartment data from the property management computer and to update said centralized apartment reservation database to reflect changes in the apartment data received from the property management computer;
said centralized apartment reservation server further configured to present a centralized apartment reservation web page to the user via the user computer to facilitate checking the availability of at least one specific apartment unit;
said centralized apartment reservation server further configured to allow the user to browse unit level data; and
said centralized apartment reservation server further configured to receive a request to reserve a specific unit, to remove said specific unit from availability in said centralized apartment reservation database, and to send an alert to a property management system for said apartment complex.

37. A method for aggregating unit level property management data for apartments from among at least two property management systems, the method comprising the steps of:
retrieving unit level apartment data from a property management database associated with a property management computer;
transmitting said unit level apartment data to a centralized apartment reservation server; and
updating a centralized apartment reservation database, associated with said centralized apartment reservation server, with said unit level apartment data, wherein said unit level apartment data comprises unit level data on specific property units, wherein said unit level property management data in said centralized apartment reservation database is transmitted from among at least two property management systems with each having a property management computer.

38. A method of facilitating online reservation of an apartment comprising the steps of:
aggregating unit and model level information, for more than one apartment complex and more than one property management system, within a centralized apartment reservation database, wherein said centralized apartment reservation database substantially reflects the availability status of individual apartment units in more than one property management databases;
presenting said model level information for at least one apartment complex, wherein said model level information comprises at least the availability of models within said at least one apartment complex;
receiving a user selection of at least one model type; presenting said unit level information, wherein said unit level information comprises at least the availability of an apartment unit of said at least one model type; and
reserving a selected apartment unit in said centralized apartment reservation database.
